(19) United States
(12) Patent Application Publication
(10) Pub. No.: US 2008/0235910 A1
(43) Pub. Date: Oct. 2, 2008

(54) Hinge

(76) Inventor: Trevor J. UMBACK, Blacktown (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/079,691

(22) Filed: Mar. 28, 2008

(30) Foreign Application Priority Data
Mar. 30, 2007 (AU) 2007901713

(51) Int. Cl. E05D 5/12

(52) U.S. Cl. 16/382

(57) ABSTRACT

A hinge assembly (1) to pivotally attach a door to a door jamb having a first hinge half (5) to be attached to the jamb and including a passage (10) extending generally vertically. The passage (10) having a threaded length (12); a second hinge half (15) to be attached to the door and including a passage (20) extending generally vertically and to be located above and axially aligned with the first hinge half passage. A pivot pin (25) to be located in both passages to pivotally attach the door to the jamb.

### CROSS-REFERENCE TO RELATED APPLICATIONS

This application claims priority to Australian Provisional Application No. 2007901713, filed Mar. 30, 2007, the disclosure of which is herein incorporated by reference.

### FIELD OF THE INVENTION

The present invention relates to hinges and in particular to an adjustable hinge for a door.

### BACKGROUND OF THE INVENTION

It is typical for a door to be attached to the door frame by two or more hinges. Each hinge includes two halves or wings, one screwed to the door jamb and the other screwed to the door. A locking pivot pin is inserted between the halves to pivotally secure the halves together.

Though this arrangement secures a door to the door jamb, it does not take into consideration the fact that most structures move during their life. This commonly causes doors to become misaligned within the door frame. These movements occur because of wet and dry seasonal weather, bad construction or renovations, foundation movement, cracks and slipping of the footings or slab.

To correct the misalignment of a door it is typical to remove the door by either unscrewing the hinge plates from either the door jamb or door, or hammering the pin out from between the hinge plates. The door can then be planed on one or more edges to realign the door within the door opening.

Further, when moving furniture or white goods between rooms the hinges and the end of the door limit the size of the door opening. If the door is to be removed to allow better access, again the hinge plates must be unscrewed or the pin must be hammered out from between the hinged plates.

Accordingly, there is a need to provide a door hinge which allows doors to be easily removed from the door opening and/or easily adjusted to correct misalignment.

### OBJECT OF THE INVENTION

It is an object of the present invention to overcome or ameliorate some of the disadvantages of the prior art or at least to provide a useful alternative.

### SUMMARY OF THE INVENTION

There is firstly disclosed herein a hinge assembly to pivotally attach a door to a door jamb, said assembly including;

a first hinge half to be attached to the jamb and including a passage extending generally vertically, said passage having a threaded length;

a second hinge half to be attached to the door and including a passage extending generally vertically and to be located above and axially aligned with the first hinge half passage; and

a pivot pin to be located in both passages to pivotally attach the door to the jamb, the pin having a threaded length to threadably engage in the first hinge half passage, and a further length slidably received in the passage of said second hinged half to provide for pivoting of said door about a generally vertical axis, with rotation of said pin about said axis causing movement of said further length between an extended position projecting into the second hinge half passage and a retracted position at least substantially withdrawn from the second hinge half passage.

Preferably, each said hinge half includes apertures for receipt of a fastener to secure said hinge half to said door or jamb.

Preferably, said assembly includes a bearing located at least partially between said passages.

Preferably, said assembly includes a spacer located between said passages.

Preferably, said passage of said second hinge half is closed at one end.

Preferably, the end of said pin adjacent said threaded length includes a recess operatively associated with a tool to rotate said pin.

Preferably, said first and second hinge halves are symmetrical.

### BRIEF DESCRIPTION OF THE DRAWINGS

A preferred form of the present invention will now be described by way of example only with reference to the accompanying drawings wherein:

FIG. 1 is a sectional view of a door hinge according to an embodiment of the invention;

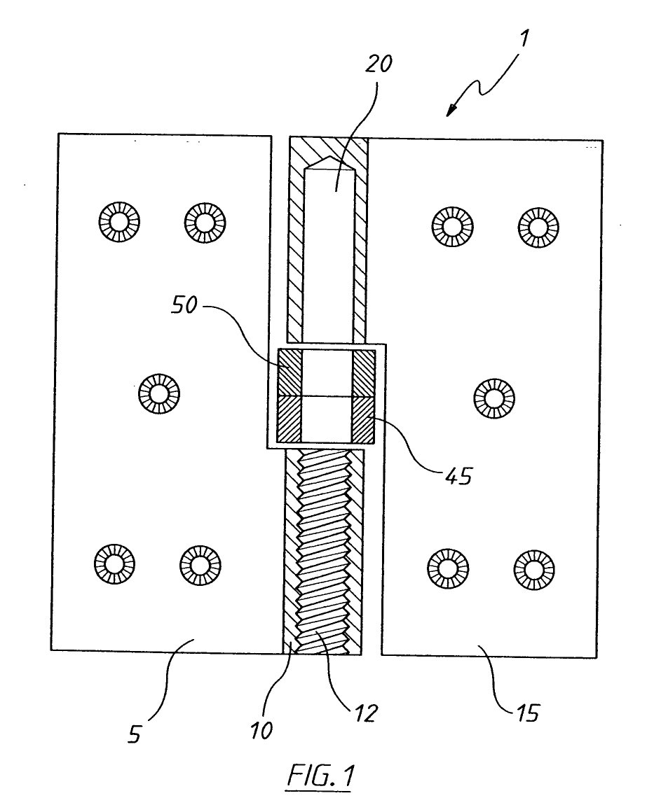

FIG. 2 is a cross-sectional view of a door hinge of a further embodiment of the invention;

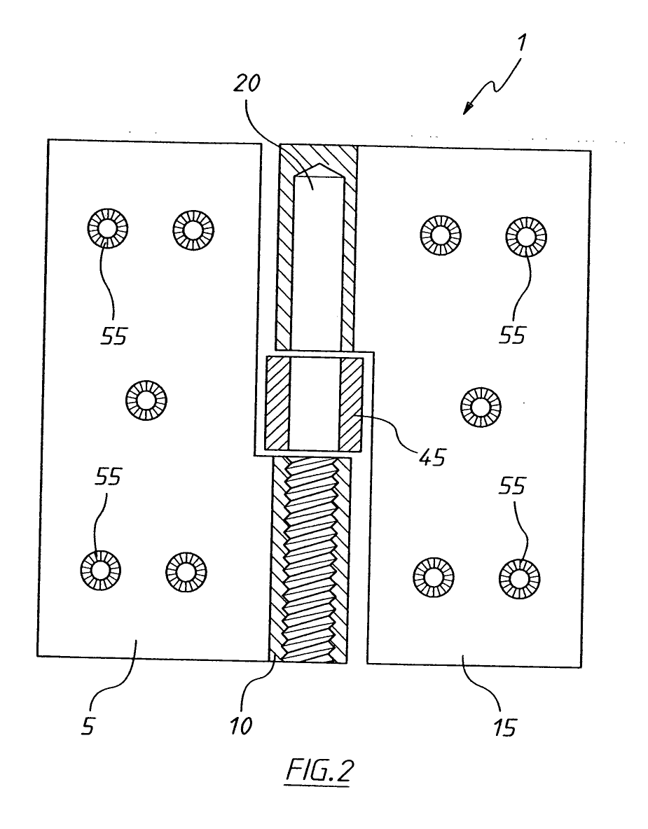

FIGS. 3 and 4 are cross-sectional views of the locking pin;

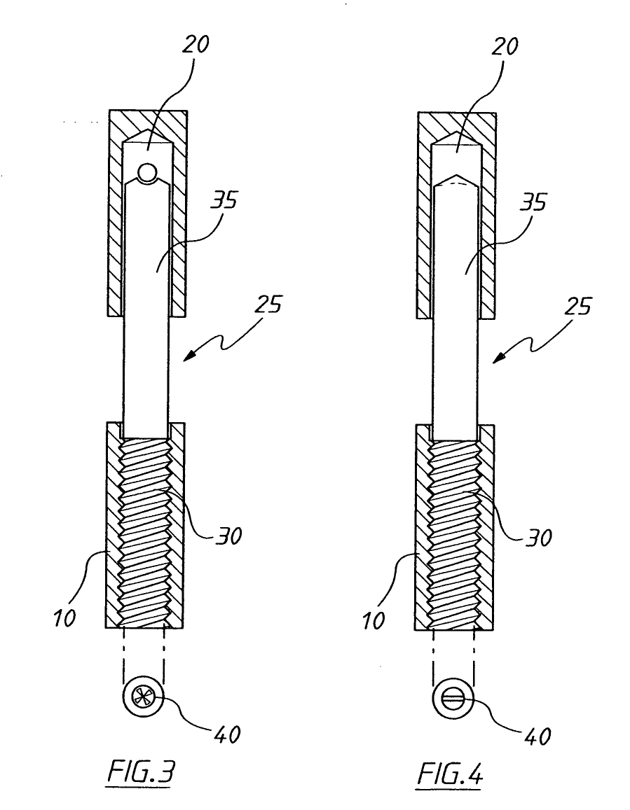

FIG. 5 is a sectional view of a door hinge according to an embodiment of the invention;

FIG. 6 is a cross-sectional view of a door hinge of a further embodiment of the invention; and

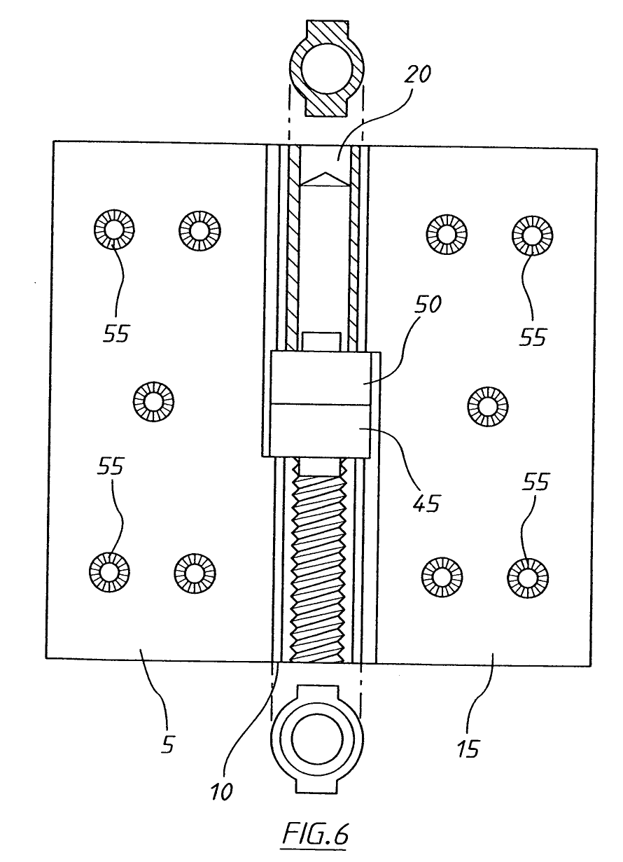

FIGS. 7a, 7b and 7c are cross-sectional views of pin and passages of a further embodiment of the invention.

### DETAILED DESCRIPTION OF THE PREFERRED EMBODIMENTS

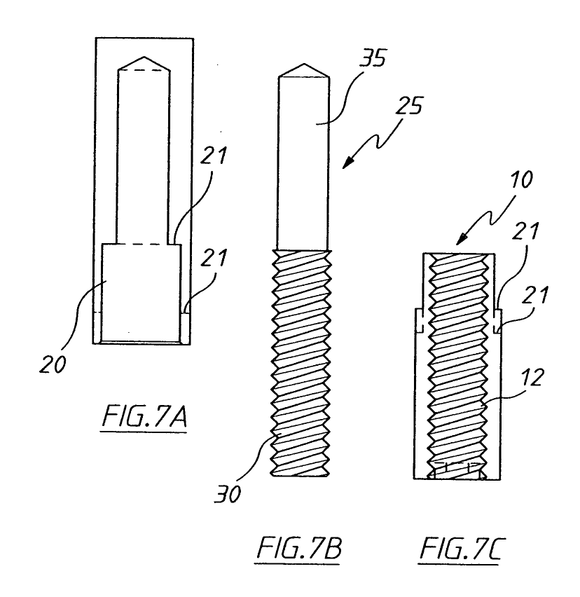

In the accompanying drawings, there is schematically depicted a hinge assembly 1 to pivotally attach to a door or door jamb. The assembly 1 includes a first hinge half 5 to be attached to the jamb and including a passage 10 extending generally vertically. The passage 10 having a threaded length 12. A second hinge half 15 to be attached to the door and including a passage 20 extending generally vertically and to be located above and in axial alignment with the passage 10 of the first hinge half 5. A pivot pin 25 is located in both passages 10, 20 to pivotally attach the door to the jamb. The pin 25 having a threaded length 30 to threadably engage the threaded length 12 of the first hinge half passage 10 and a further length 35 slidably received in the passage 20 of the second hinge half 15 to provide for pivoting of the door about a generally vertical axis. The threaded passage 10 and threaded pin length 30 can be right or left hand threads. Rotation of the pin 25 about the axis causes movement of the further length 35 between an extended position projecting into the second hinge half passage 20 and a retracted position at least substantially withdrawn from the second hinge half passage 20. The passages 10 and 20 can include a step 21 or the like as best seen in FIGS. 7a and 7c. The pin 25 further includes a recess 40 located at an end of the pin 25 adjacent the threaded length 30. The recess 40 being operatively associated with a tool such as a screwdriver, allen key, or the like to cause movement of the pin 25 about the axis.

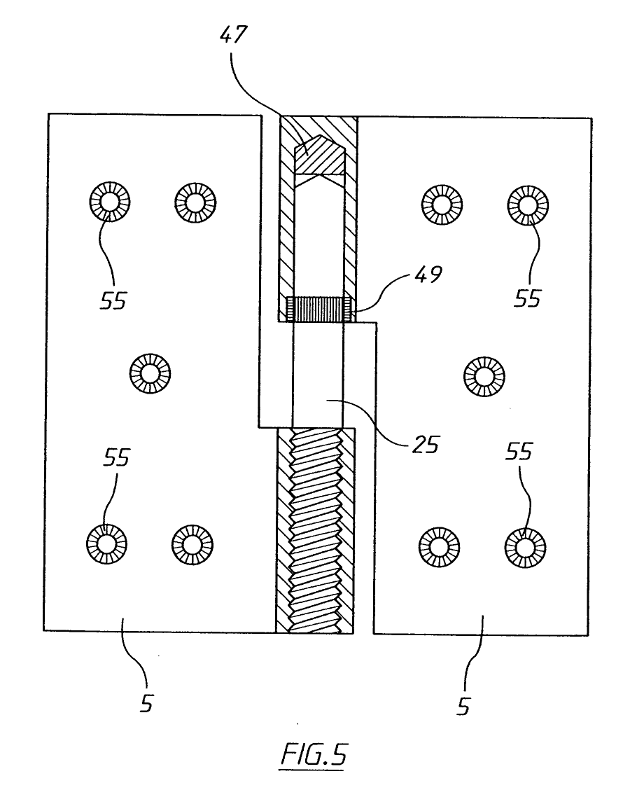

The assembly 1 can be manufactured of most standard materials and include various types of finishes to suit. The assembly 1 can further include a spacer 45 or bearing 50 located at least partially between the passages 10, 20 about the pin 25 to assist in pivoting of the pin 25 about the axis. The collar or spacer 45 can be made in 2 mm widths and be of a “C” shaped configuration to allow ease of use as the door is being adjusted. The passage 20 of the second hinge half 15 can be closed at one end and include supports therein such as ball bearings, caps and buffers to assist in supporting and pivoting of the door. As seen in FIG. 5, a damper block 47 could also be used within the passage 20 to improve the pivoting motion when opening or closing the door. When using the assembly 1 outside a structure, nylon or plastic inserts 49 (see FIG. 5) or bearings can be utilised at the start of the passages 10, 20 to assist in longevity and overcoming the elements. The first and second hinge halves 5, 15 also include apertures 55 for receipt of fasteners such as nails, screws, bolts or the like to secure the first and second hinge halves 5, 15 to the door and door jamb.

In use, if a door having the abovementioned assembly 1 needs to be removed from the door opening or needs to be vertically adjusted, a user selects the required tool, such as, a screwdriver, alien key or the like placing the tip of the tool in the recess 40 and rotating in the required direction to move the pin 25 in either a forward or backward direction along the axis of the pin. This will either raise or lower the door. In the preferred form the door can be adjusted up or down by about 10 mm. If the door is to be removed completely the pin 25 would be unscrewed by the user substantially out of the passage 20 of the second half 15 so that the door can be removed.

The assembly 1 at-least in a preferred embodiment provides significant advantages over existing systems because it provides the ability to easily adjust the vertical alignment of a door in respect to a door opening with the use of a standard tool and with no need for specialised training. The assembly further preferably provides the ability to easily remove and replace a door to better provide access between rooms, improve safety and access for emergency services, wheelchair access, or the like. Further, the paintwork surrounding the door will not be effected even if the hinges have been painted over as the pin is the only part of the assembly 1 required to be removed or adjusted. The assembly 1 can be utilised on any type of door, such as a room door or cupboard door or the like. Significant advantages are also possible when used in a marine environment.

Although the invention has been described with reference to specific examples, it will be appreciated by those skilled in the art that the invention may be embodied in many other forms.

1. A hinge assembly to pivotally attach a door to a door jamb, said assembly including:
a first hinge half to be attached to the jamb and including a passage extending generally vertically, said passage having a threaded length;
a second hinge half to be attached to the door and including a passage extending generally vertically and to be located above and axially aligned with the first hinge half passage; and
a pivot pin to be located in both passages to pivotally attach the door to the jamb, the pin having a threaded length to threadably engage in the first hinge half passage, and a further length slidably received in the passage of said second hinged half to provide for pivoting of said door about a generally vertical axis, with rotation of said pin about said axis causing movement of said further length between an extended position projecting into the second hinge half passage and a retracted position at least substantially withdrawn from the second hinge half passage.

2. The hinge according to claim 1, wherein said hinge half includes apertures for receipt of a fastener to secure said hinge half to said door or jamb.

3. The hinge according to claim 1, wherein said assembly includes a bearing located at least partially between said passages.

4. The hinge according to claim 1, wherein said assembly includes a spacer located between said passages.

5. The hinge according to claim 1, wherein said passage of said second hinge half is closed at one end.

6. The hinge according to claim 1, wherein said pin adjacent said threaded length includes a recess operatively associated with a tool to rotate said pin.

7. The hinge according to claim 1, wherein said first and second hinge halves are symmetrical.
